(19) United States
(12) Patent Application Publication
(10) Pub. No.: US 2009/0322216 A1
(43) Pub. Date: Dec. 31, 2009

(54) DISPLAY DEVICE, DISPLAY DEVICE MANUFACTURING METHOD AND DISPLAY METHOD

(75) Inventor: Hirokazu YANAGIHARA, Chino-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/472,727

(22) Filed: May 27, 2009

(30) Foreign Application Priority Data
Jun. 25, 2008 (JP) 2008-165527

(51) Int. Cl. H01J 1/62; H01J 1/53; H01J 9/20

(52) U.S. Cl. 313/504; 313/505; 445/52

(57) ABSTRACT

A display device includes: a plurality of first pixel electrodes which are arranged in a first direction and a second direction intersecting the first direction; a plurality of second pixel electrodes which are arranged in the first and second directions; a counter electrode which is formed to be opposed to the plurality of first pixel electrodes and the plurality of second pixel electrodes; a first power supply line which electrically connects the plurality of first pixel electrodes; and a second power supply line which electrically connects the plurality of second pixel electrodes. One or more pixels are formed to correspond to the respective pixel electrodes of the plurality of first pixel electrodes and the plurality of second pixel electrodes. A light-emitting layer made of an organic light-emitting material or an insulating layer made of an organic compound is disposed between a first electrode which is one of the plurality of first pixel electrodes and the counter electrode and between a second electrode which is one of the plurality of second pixel electrodes and the counter electrode. Power is supplied to the plurality of first pixel electrodes via the first power supply line upon displaying a first image and power is supplied to the plurality of second pixel electrodes via the second power supply line upon displaying a second image.

### BACKGROUND

1. Technical Field

The present invention relates to a display device, a display device manufacturing method and a display method.

2. Related Art

In recent years, a large number of display devices using, as display elements, electroluminescent elements (EL elements) which are thin spontaneous light-emitting elements have been used. The EL elements have a structure in which plural functional layers including at least a light-emitting layer made of a light-emitting material are formed between an anode as a pixel electrode and a cathode as a counter electrode. A voltage is applied between the anode and the cathode to flow a predetermined current to the functional layers and thus the light-emitting layer emit light and the light having desired brightness is emitted. Particularly, organic EL panels which have, as pixels, organic EL elements made using an organic material as a light-emitting material and in which the pixels are arranged in a matrix to form an image display range have been widely known.

Image display of an organic EL panel is performed in such a manner that a predetermined voltage is applied to an anode formed for each pixel by a switching operation of a driving element such as a thin-film transistor (TFT) formed for each pixel to flow a predetermined current to a cathode formed as an electrode common to all the pixels. Thus, generally, an organic EL panel has an anode formed for each pixel and displays an image in a display range by a separate switching operation of a driving element formed for each pixel.

Accordingly, in a known organic EL panel, a driving element and wiring (for example, a gate line and a data line) for a switching operation of the driving element are required for each pixel. In addition, it is necessary to control the switching operation of the driving element for each pixel and thus the structure of the organic EL panel is complicated.

When an image to be displayed in the organic EL panel is the same image, that is, a fixed image, it is preferable that a light-emitting pattern corresponding to the fixed image is displayed without the switching operation of the driving element for each pixel. A technique related to such a display method is disclosed in, for example, JP-A-2001-188489.

The technique disclosed in JP-A-2001-188489 is that a display section formed of EL elements having plural light-emitting patterns corresponding to fixed images is provided to be operated in an order of the previously stored light-emitting patterns. Accordingly, a display device not requiring a driving element and wiring for a switching operation of the driving element for each pixel and not requiring control of the switching operation of the driving element for each pixel is achieved. As a result, there is an advantage in that the structure of the organic EL panel is simplified.

However, in the technique disclosed in JP-A-2001-188489, although plural fixed images which are displayed by the plural light-emitting patterns are different from each other, the plural fixed images which are displayed by the plural light-emitting patterns are sharing images sharing one fixed image in the entire display section. Thus, a difference corresponding to a size of the image which is displayed is caused in the plural fixed images. Further, the respective fixed images cannot be displayed in the entire display section.

Moreover, in the technique disclosed in JP-A-2001-188489, regarding each light-emitting pattern, an area of a light-emitting portion in a total area of the light-emitting pattern varies in accordance with a position provided in the display section. As a result, there is a disadvantage in that display qualities of the displayed images are not the same depending on the light-emitting patterns.

### SUMMARY

An advantage of some aspects of the invention is that it provides a display device, a display device manufacturing method and a display method.

According to an aspect of the invention, a display device includes: a plurality of first pixel electrodes which are arranged in a first direction and a second direction intersecting the first direction; a plurality of second pixel electrodes which are arranged in the first and second directions; a counter electrode which is formed to be opposed to the plurality of first pixel electrodes and the plurality of second pixel electrodes; a first power supply line which electrically connects the plurality of first pixel electrodes; and a second power supply line which electrically connects the plurality of second pixel electrodes. One or more pixels are formed to correspond to the respective pixel electrodes of the plurality of first pixel electrodes and the plurality of second pixel electrodes. A light-emitting layer made of an organic light-emitting material or an insulating layer made of an organic compound is disposed between a first electrode which is one of the plurality of first pixel electrodes and the counter electrode and between a second electrode which is one of the plurality of second pixel electrodes and the counter electrode. Power is supplied to the plurality of first pixel electrodes via the first power supply line upon displaying a first image and power is supplied to the plurality of second pixel electrodes via the second power supply line upon displaying a second image.

According to this configuration, the pixel which is formed in the respective pixel electrodes electrically connected to the power supply line emits light or does not emit light depending on the supply of power to the power supply line. Accordingly, different images can be displayed in accordance with the power supply line supplying the power. Moreover, at this time, the pixel electrodes are arranged in the first and second directions intersecting each other to disperse the images which are displayed. Thus, since the different images can be displayed in a dispersed manner, it can be anticipated that the displayed images have almost the same display area. As a result, it can be anticipated that reduction in display quality of the respective displayed images is suppressed.

In the display device according to this aspect, the insulating layer has a light-shielding property.

According to this configuration, a leak of light from the pixel not emitting light can be prevented.

According to another aspect of the invention, a display device has an image display range in which a plurality of pixels are arranged in a matrix in a first direction and a second direction intersecting the first direction and displays a plurality of images in the image display range. One pixel or a pixel group of two or more pixels adjacent to each other in the first and second directions is classified as a unit pixel area in the display range. The respective unit pixel areas display a partial image belonging to one of the plurality of images, and the one image to which the partial images displayed by the unit pixel areas belong is displayed differently in the unit pixel areas adjacent to each other in the first and second directions.

According to this configuration, upon displaying plural images in the display range, the unit pixel areas displaying one image are not adjacent to each other in the first and second directions and thus the unit pixel areas are dispersed in the entire display range. Accordingly, since the plural images can be displayed by the unit pixel areas dispersed in the entire display range, it can be anticipated that the displayed images have almost the same display area. In addition, it is highly possible that due to the dispersion of the unit pixel areas, a distribution density of the unit pixel areas with respect to the display area is almost the same in the displayed images. As a result, it can be anticipated that reduction in display quality of the respective displayed images is suppressed.

In the display device according to this aspect, the pixels included in the unit pixel area are arranged in the same manner in all the unit pixel areas, except for a peripheral portion of the display range.

In this manner, the unit pixel areas are the same in shape and the number of pixels included therein, except for a peripheral portion of the display range, and thus a distribution density of the unit pixel areas with respect to the display area is almost the same in the displayed images. As a result, it can be anticipated that display qualities of the plural images which are displayed in the display range are almost the same.

In the display device according to this aspect, the plurality of pixels have an organic layer including a first electrode, a second electrode and a light-emitting layer sandwiched between the first electrode and the second electrode to emit light from the light-emitting layer by a current flowing between the first electrode and the second electrode. The first electrode is electrically connected between the pixels present in all the unit pixel areas belonging to the one image, and the second electrode is electrically connected between all the pixels formed in the display range.

In this manner, the electrically connected pixels in all the unit pixel areas belonging to one image can simultaneously emit light by applying a voltage between the first electrode and the second electrode. Accordingly, without controlling a switching operation of a driving element for each pixel, one image can be easily displayed in the substantially entire display range.

In the display device according to this aspect, the plurality of pixels are classified into the pixels emitting light and the pixels not emitting light in accordance with the one image in the respective unit pixel areas belonging to the one image. The organic layers of the pixels not emitting light include as the light-emitting layer a layer made of an organic compound having an electrical insulating property.

In this manner, the pixels (for example, pixels displaying black) classified as the pixels not emitting light in one image can be easily formed.

In the display device according to this aspect, the pixels emitting light emit light having a color determined in accordance with the one image in the respective unit pixel areas belonging to the one image.

In this manner, the pixels in the unit pixel areas belonging to one image emit light and thus the respective unit pixel areas can display a color in accordance with the display contents of the one image.

According to further another aspect of the invention, a method of manufacturing the display device includes: forming at least the light-emitting layer in the respective pixels by an ink jet system discharging a functional liquid including a material for forming the light-emitting layer.

According to this method, in accordance with the display contents of one image to be displayed, the organic layer to be formed for each pixel in the unit pixel areas belonging to the one image can be easily changed for each pixel. Accordingly, for example, even when one image to be displayed is different depending on display devices, the respective display devices can be easily manufactured by changing a functional liquid to be discharged for each pixel. In addition, since an amount of the functional liquid to be discharged can be adjusted for each pixel, a quantity of light to be emitted for each pixel can be easily adjusted. As a result, luminance of at least a partial image belonging to one image to be displayed can be adjusted.

According to still further another aspect of the invention, in a display method of displaying a plurality of images in an image display range in which a plurality of pixels are arranged in a matrix in a first direction and a second direction intersecting the first direction, one pixel or a pixel group of two or more pixels adjacent to each other in the first and second directions serves as a unit pixel area in the display range. When the respective unit pixel areas display a partial image belonging to one of the plurality of images, the one image to which the partial images displayed by the unit pixel areas belong is displayed differently in the unit pixel areas adjacent to each other in the first and second directions.

According to this method, upon displaying plural images in the display range, the unit pixel areas displaying one image are not adjacent to each other in the first and second directions and thus the unit pixel areas are dispersed in the entire display range. Accordingly, the plural images can be displayed by the unit pixel areas dispersed in the entire display range. As a result, it can be anticipated that the displayed images have almost the same display area. In addition, it is highly possible that due to the dispersion of the unit pixel areas, a distribution density of the unit pixel areas with respect to the display area is the same in the displayed images. As a result, it can be anticipated that reduction in display quality of the displayed images is suppressed.

### BRIEF DESCRIPTION OF THE DRAWINGS

The invention will be described with reference to the accompanying drawings, wherein like numbers reference like elements.

FIG. 1 is a schematic diagram illustrating an example of a known organic EL panel.

FIG. 2 is a schematic diagram illustrating an entire layout of an organic EL panel according to an embodiment.

FIG. 3 is a schematic diagram illustrating the electric connection between anodes and power supply lines.

FIG. 4A is a schematic diagram illustrating a state in which the formation of an organic EL element is completed.

FIG. 4B is a schematic diagram illustrating the formation of a light-emitting layer of the organic EL element by discharging and applying a functional liquid.

FIG. 5 is a schematic diagram illustrating the arrangement of nozzles bored in a discharge head.

FIG. 6 is a diagram schematically illustrating a scanning method of the discharge head.

FIGS. 7A and 7B are explanatory diagrams illustrating an example of an image which is displayed.

FIG. 8 is a schematic diagram illustrating a portion of a wiring state on a substrate in a first modified example.

FIG. 9 is a schematic diagram illustrating a portion of a wiring state on a substrate in the first modified example.

FIG. 10 is a schematic diagram illustrating a portion of a wiring state on a substrate in a second modified example.

FIG. 11 is a schematic diagram illustrating the case in which two images are displayed in a display range in a third modified example.

FIG. 12 is a schematic diagram illustrating the case in which three images are displayed in a display range in a fourth modified example.

### DESCRIPTION OF EXEMPLARY EMBODIMENTS

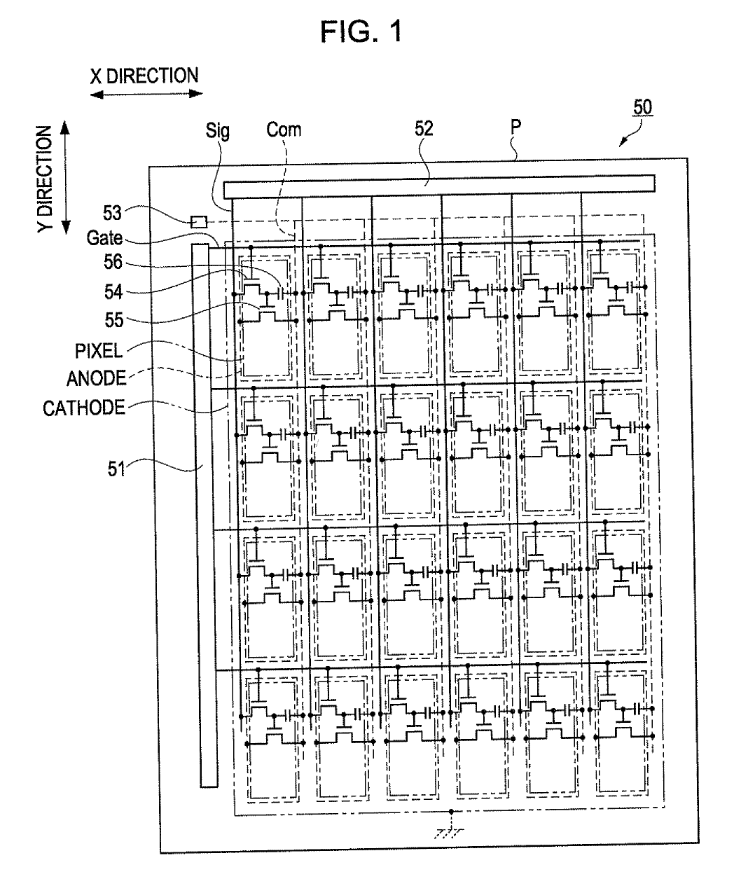

As an embodiment of a display device to which the invention is applied, an organic electroluminescent (EL) panel will be described. However, before the description, the configuration of a known organic EL panel will be described using FIG. 1 to easily understand advantages of the embodiment.

FIG. 1 is a schematic diagram illustrating a circuit configuration and an entire layout of an organic EL panel 50 as an example of a known organic EL panel. The organic EL panel 50 is an active matrix display device in which each pixel is driven to make a display. The pixels are partitioned by a partition wall made of resin or the like on a substrate P having a rectangular shape and thus each pixel has a rectangular area. The pixels are regularly arranged in a substantially center portion of the substrate P in an X direction and a Y direction substantially perpendicular to each other to form a display range. The pixels may be partitioned into oval or annular areas having a shape other than the rectangular shape.

In each pixel, an organic EL element is formed as a display element, and thin-film transistors (TFT) 54 and 55 for driving the organic EL element to make a display (that is, emission of light) and a holding capacitor 56 are formed as a driving element. Herein, the organic EL element has a top emission structure in which light is emitted from a display element-forming face to the substrate P. Accordingly, the driving element is positioned to overlap the display element in plan view and formed between the substrate P and the display element. However, the organic EL element may not have the top emission structure and may have a bottom emission structure in which light is emitted from the opposite side to the display element-forming face to the substrate P.

A scanning driving circuit 51, a data driving circuit 52 and a feed terminal 53 are formed at the outer peripheral portion of the substrate P. As illustrated in FIG. 1, a scanning line Gate from the scanning driving circuit 51, a data line Sig from the data driving circuit 52 and a power supply line Com connected to the feed terminal 53 are arranged for the driving element formed for each pixel, so the display element is driven to emit light,

First, the scanning line Gate is connected to a gate of the TFT 54 to control ON/OFF switching of the TFT 54 in accordance with a current signal supplied via the scanning line Gate. When the TFT 54 is switched on, a predetermined voltage is held in the holding capacitor 56 by power supplied from the power supply line Com in accordance with an image signal supplied from the data line Sig connected to a source of the TFT 54. Then, the voltage held in the holding capacitor 56 is applied to a gate of the TFT 55 and thus the TFT 55 is switched on. A source and a drain of the TFT 55 are connected to the power supply line Com and an anode as a pixel electrode, respectively, to apply a current to the anode via the power supply line Com in accordance with the voltage held in the holding capacitor 56, that is, an image signal.

The display element formed for each pixel emits light by flowing a current between the anode and a cathode as a counter electrode. That is, the light having brightness corresponding to an image signal is emitted by flowing the current applied to the anode to the cathode formed over the surfaces of all the pixels. Therefore, in this manner, in the organic EL panel 50, a switching operation performed by the driving element is controlled for each pixel in accordance with an image signal and thus various images are displayed.

In addition, in some cases, in order to display a color image, the display element formed for each pixel is configured to emit light of red (R), green (G) or blue (B) so as to display a predetermined color image such as an image or a character. For the sake of simplicity of the description, the organic EL panel 50 has a display range in which the total twenty-four pixels of four pixels in the Y direction (vertical direction in the drawing)×six pixels in the X direction (horizontal direction in the drawing) are arranged, as illustrated in FIG. 1. However, actually, the display range is formed by a large number of pixels, for example, several hundreds of pixels arranged in the X and Y directions.

In the known organic EL panel 50 having such a configuration, a character, a pattern or an image (these are collectively referred to as “image”) displayed in the display range may display a predetermined image, that is, a fixed image. In this case, among all the pixels in the display range, the pixels emitting light can be uniquely set in accordance with the display contents of the fixed image. Accordingly, when the fixed image is displayed, the switching operation of the driving element in accordance with an image signal is not necessarily performed for each pixel, and it is preferable that a voltage is applied to the anodes of the pixels which are set to display the fixed image in accordance with the fixed image.

For example, an organic EL panel according to this embodiment separately displays two fixed images in an entire display range thereof. Accordingly, a switching operation of the driving element is not required and thus the organic EL panel has a simplified structure. In addition to this, the organic EL panel is contrived to suppress reduction in display qualities of the two fixed images displayed. Hereinafter, the organic EL panel according to this embodiment will be described with reference to the drawings.

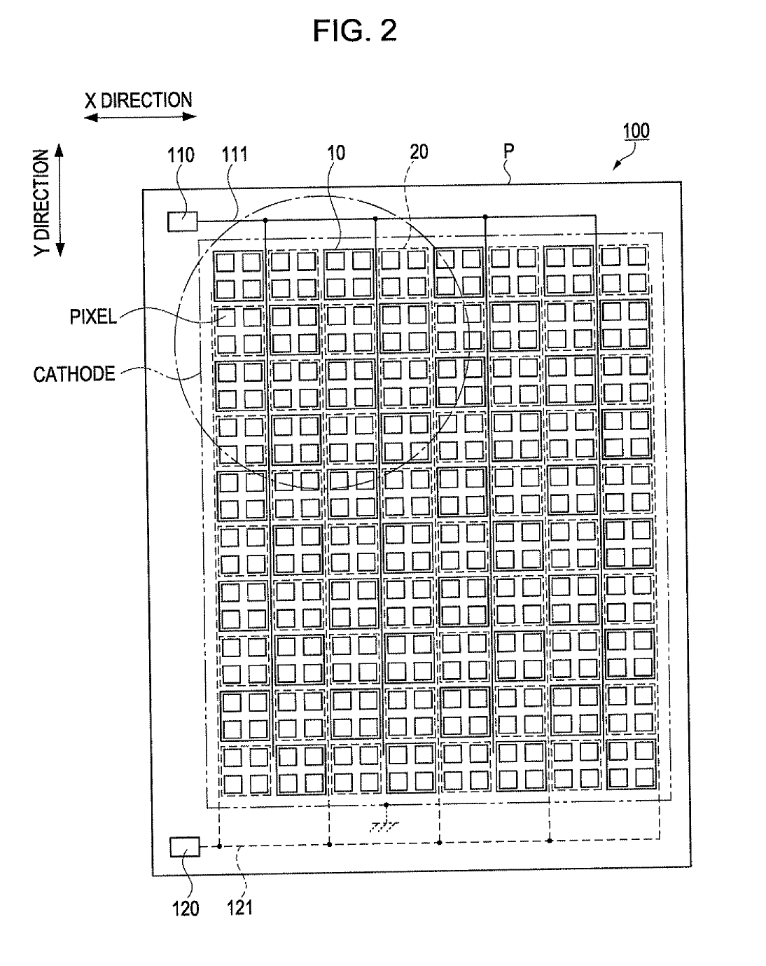

FIG. 2 is a schematic diagram illustrating a circuit configuration and an entire layout of an organic EL panel 100 according to this embodiment. The organic EL panel 100 is a display device in which anodes as pixel electrode formed for respective pixels are electrically connected in accordance with a fixed image to be displayed. The pixels are partitioned by a partition wall made of resin or the like on a substrate P having a rectangular shape and thus each pixel has a rectangular area having a substantially square shape. The pixels are regularly arranged in a substantially center portion of the substrate P in an X direction and a Y direction intersecting each other to form a display range.

In this embodiment, the X and Y directions are substantially perpendicular to each other. However, the directions are not limited to this and may intersect each other at an angle other than a right angle. Furthermore, in this embodiment, for the sake of simplicity of the description, the organic EL panel 100 has a display range in which the total 320 pixels of twenty pixels in the Y direction (vertical direction in the drawing)×sixteen pixels in the X direction (horizontal direction in the drawing) are arranged, as illustrated in FIG. 2. However, actually, the display range is formed to have a large number of pixels, for example, several hundreds of pixels arranged in the X and Y directions. In addition, the pixels may be partitioned into areas having a rectangular shape other than the square shape or oval or annular areas having a shape other than the rectangular shape.

In each pixel, an organic EL element is formed as a display element. Herein, the organic EL element emits white light when emitting the light. However, the invention is not limited to this and light having a color other than white may be emitted. In addition, the organic EL element has a top emission structure in which light is emitted from a display element-forming face to the substrate P. However, the organic EL element may not have the top emission structure and may have a bottom emission structure in which light is emitted from the opposite side to the display element-forming face to the substrate P.

In this embodiment, the total four pixels of two pixels in the X direction×two pixels in the Y direction form one group (hereinafter, referred to as “unit pixel area”) and one common anode is formed for each group. Further, one common anode 10 (full line in the drawing) is formed in a unit pixel area for displaying one (referred to as “image A”) of the two fixed images which are displayed in the display range and one common anode 20 (broken line in the drawing) is formed in a unit pixel area for displaying the other fixed image (referred to as “image B”). The anodes 10 and 20 are alternately formed in the X direction and the Y direction so that all the anodes 10 are not adjacent to each other and all the anodes 20 are not adjacent to each other.

A feed terminal 110 and a feed terminal 120 are formed at the outer peripheral portion of the substrate P. A power supply line 111 is arranged and connected to the feed terminal 110. A power supply line 121 is arranged and connected to the feed terminal 120.

The power supply line 111 is arranged so as to supply a predetermined voltage supplied to the feed terminal 110 to all the formed anodes 10 when the image A is displayed in the display range. Similarly, the power supply line 121 is arranged so as to supply a predetermined voltage supplied to the feed terminal 120 to all the formed anodes 20 when the image B is displayed in the display range. By flowing a current between the anodes and a cathode as a counter electrode formed over the surfaces of all the pixels, the organic EL element formed for each pixel is driven to emit light and the image A or B is displayed

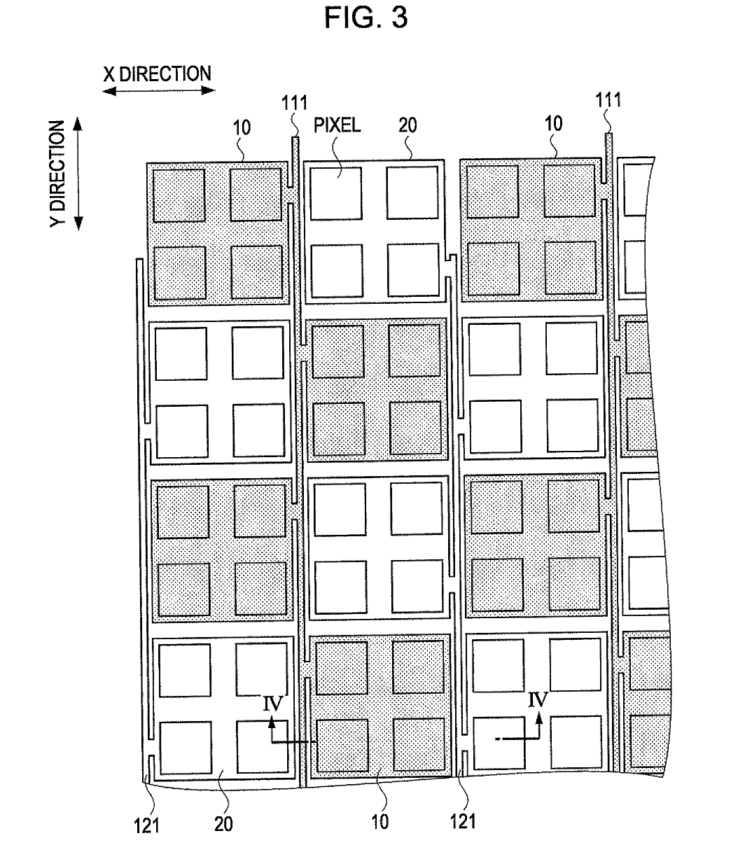

A specific wiring state between the power supply lines 111 and 121 and the anodes 10 and 20 will be described using FIG. 3 FIG. 3 is a schematic view illustrating electric connection between the anodes 10 and 20 and the power supply lines 111 and 121. In this drawing, a portion surrounded by a circle (alternate long and short dash line) in FIG. 2 is enlarged to be illustrated.

As illustrated in the drawing, the power supply lines 111 and 121 are arranged to extend in the Y direction at the end of the anodes 10 or the anodes 20 in the X direction and in a gap between the anodes 10 and 20, respectively. Moreover, the power supply lines 111 and 121 are alternately formed at intervals of one gap between the anodes 10 and 20 in the X direction. The power supply line 111 is electrically connected to all the anodes 10 disposed in the Y direction in which the power supply line 111 extends, and the power supply line 121 is electrically connected to all the anodes 20 disposed in the Y direction in which the power supply line 121 extends. By such wiring, the wiring formed in the gap between the anodes 10 and 20 can be reduced. In this embodiment, it is preferable that there is a gap for arranging one of the power supply line 111 and the power supply line 121. Accordingly, an area of the anodes, that is, an area of the pixels can be increased. As a result, reduction in brightness of the image A or the image B can be suppressed.

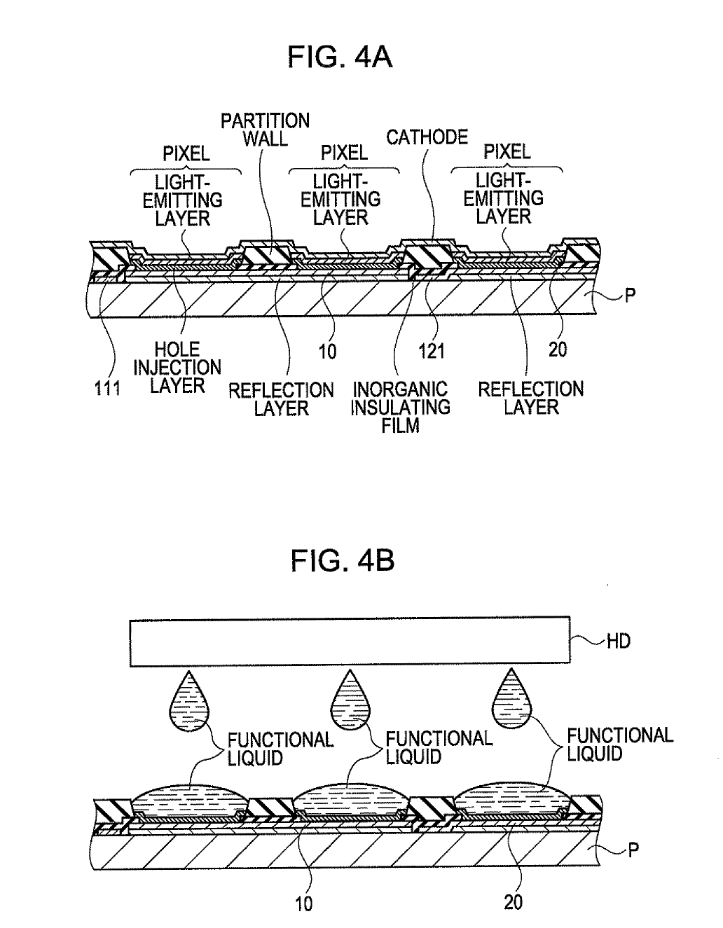

Next, the organic EL elements formed in the organic EL panel 100 according to this embodiment will be described in detail with reference to FIGS. 4A and 4B. FIGS. 4A and 4B are schematic diagrams illustrating the configuration of the functional layers formed for each pixel in the organic EL panel 100 according to this embodiment. FIG. 4A is a schematic cross-sectional view illustrating a cross-section taken along the line IVA-IVA of FIG. 3 and illustrates a state in which the formation of the organic EL element is completed. FIG. 4B is a schematic diagram illustrating a state in which a light-emitting layer of the organic EL element is formed by jetting and applying a functional liquid. Since dimensions are exaggerated for convenience of explanation, they are not necessarily the same as actual dimensions.

As illustrated in FIG. 4A, the respective pixels have a pixel area partitioned by a partition wall formed by etching or the like and made of an organic insulating material (for example, acrylic resin or polyimide resin). In the pixel area of the respective pixels, an organic EL element capable of emitting white light is formed. As illustrated in the drawing, the organic EL element is provided with a hole injection layer and a light-emitting layer formed between the anode 10 or the anode 20 and the cathode. Accordingly, the respective pixels emit light having predetermined brightness and a color (white in this embodiment) by the formed light-emitting layer.

In this embodiment, the hole injection layer is a polyethylenedioxythiophene (PEDOT)/polystyrenesulfonate (PSS) film. The light-emitting layer is a film having a predetermined thickness and formed by discharging a predetermined amount of a functional liquid having a fluoscent material as a solute showing a white color to the pixel area and performing vacuum drying and a heat treatment in a nitrogen atmosphere.

The power supply lines 111 and 121 are formed under the partition wall. By inorganic insulating films formed between the partition wall and the anodes 10 and 20, the power supply line 111 is insulated from the anode 20 and the power supply line 121 is insulated from the anode 10. The inorganic insulating film is formed so that a predetermined width thereof is exposed to the inside of the pixel area along the outer periphery of the rectangular pixel area. This is to prevent short circuit between the anodes 10 and 20 and the cathode by increasing a liquid affinity property with respect to the functional liquid for forming the hole injection layer or the light-emitting layer and forming the hole injection layer or the light-emitting layer up to the vicinity of the partition wall. When the hole injection layer or the light-emitting layer can be properly formed up to the vicinity of the partition wall, there is no need to necessarily form the inorganic insulating film. When the inorganic insulating film is not formed, it is preferable that the partition wall is configured to provide insulation between the power supply line 111 and the anode 20 and between the power supply line 121 and the anode 10.

Since the display elements according to this embodiment are top emission type organic EL elements, reflection layers made of Al or the like are formed on faces of the anodes 10 and 20 opposed to the substrate P to emit light from the side of the cathode. However, when the anodes 10 and 20 also function as the reflection layers, there is no need to form the reflection layers.

A material for the anodes 10 and 20 is not limited to a light transmissive material such as indium tin oxide (ITO), and a non-light transmissive material such as tin oxide, gold, silver or copper can be also used. In addition, the cathode is made of a light transmissive material such as ITO. A metal material which is made thin to transmit light may be also used as a material for the cathode. In this embodiment, the cathode also functions as an electron injection layer, and it is formed by, for example, depositing lithium fluoride (LiF) and aluminum (Al).

In this embodiment, as described above, the light-emitting layers are formed by an ink jet system for discharging and applying a functional liquid including an organic light-emitting material to the respective corresponding pixel areas. Specifically, as illustrated in FIG. 4B, the functional liquid is discharged to the respective pixel areas corresponding to the pixels from nozzles (not shown) provided in a discharge head HD to apply the functional liquid. Then, as described above, the vacuum drying and the heat treatment in a nitrogen atmosphere are performed to form the light-emitting layers in the pixel areas. FIG. 4B illustrates a state in which a functional liquid for forming the light-emitting layers is discharged from the discharge head HD. The hole injection layers may also be formed by discharging a functional liquid.

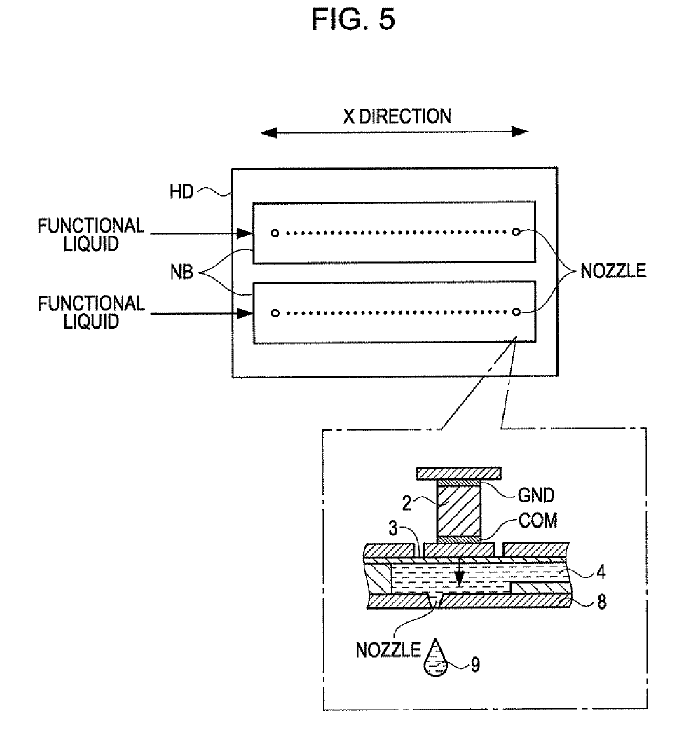

Herein, the nozzles formed in the discharge head HD according to this embodiment will be described using FIG. 5. FIG. 5 is a schematic diagram illustrating an arrangement state of the nozzles bored in the discharge head HD, as viewed from the bottom of the drawing in FIG. 4B.

In this embodiment, as illustrated in the drawing, the discharge head HD is provided with two nozzle groups NB for discharging functional liquids. The nozzle group NB has a nozzle array in which the nozzles are arranged in a substantially straight line in the X direction (horizontal direction in the drawing), and an arrangement direction thereof is coincident with the X direction. However, the nozzle array is not necessarily coincident with the X direction. For example, the nozzle array may be inclined with respect to the X direction.

In the discharge head HD, the respective bored nozzles are provided with a discharge mechanism formed for each nozzle as described above. The discharge mechanisms are configured to generate a pressure toward the functional liquid in the discharge head HD, thereby discharging a predetermined amount of the functional liquid from the nozzles. The discharge mechanisms have the same structure for all the nozzles.

In this embodiment, the discharge mechanism has a structure illustrated in the balloon of FIG. 5 and a piezoelectric element 2 serves as a driver (actuator). That is, when a predetermined voltage waveform is applied between electrodes COM and GND at the ends of the piezoelectric element 2, the piezoelectric element 2 is subjected to contraction or expansion due to an electrostrictive property thereof and a diaphragm 3 is thereby bent in a direction of the arrow in the drawing to pressurize the functional liquid in a pressurization chamber 4 formed in a mid-flow passage. As a result, the pressurized functional liquid is discharged as a droplet 9 from the nozzle bored in a bottom member 8 of the discharge head HD. The discharge mechanism can employ, for example, a so-called thermal system using a heating element as a driver.

In this embodiment, when a functional liquid is discharged using the ink jet system to form the organic EL element, functional liquids to be discharged are selectively discharged in the entire image display range in accordance with the image A or the image B for every four pixels included in the above-described respective unit pixel areas, that is, the anodes 10 and 20. This operation is performed in all the unit pixel areas of the display range to discharge the functional liquids to all the pixels.

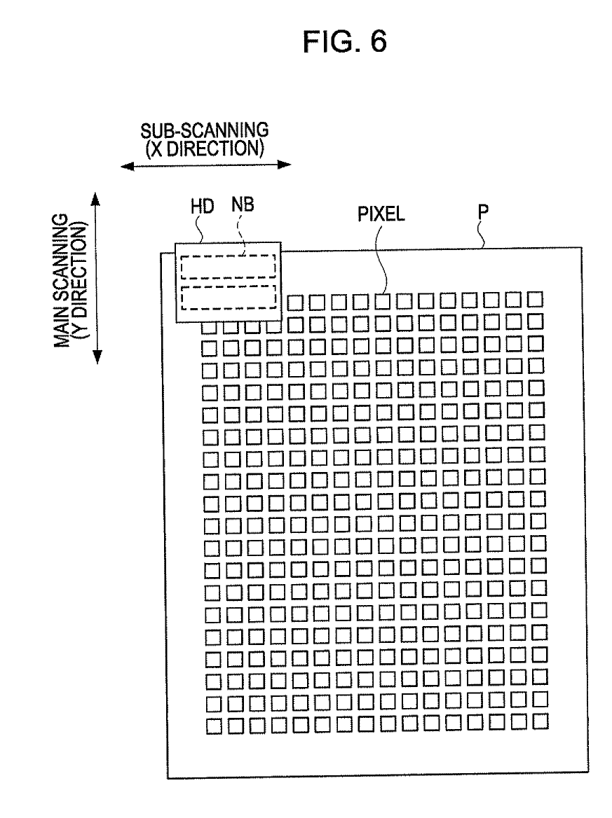

Specifically, like in the case of the scanning method schematically illustrated in FIG. 6, the substrate P and the discharge head HD are relatively moved in the Y direction (vertical direction in the drawing) as a main scanning direction and the X direction (horizontal direction in the drawing) as a sub-scanning direction. At this time, functional liquids in accordance with the respective pixels are selectively discharged from the two nozzle groups NB provided in the discharge head HD. That is, a functional liquid including an organic light-emitting material and a functional liquid including an organic insulating compound as a material are discharged in accordance with the image A or the image B from the two nozzle groups NB in the discharge head HED. Accordingly, in accordance with the image A or the image B, the respective pixels uniquely become a pixel (that is, pixel emitting light) in which a light-emitting layer is formed by the functional liquid including the light-emitting material or a pixel (that is, pixel not emitting light) in which, instead of the light-emitting layer, an insulating layer not emitting light is formed by the functional liquid including the organic insulating compound as a material. Herein, a material having a light-shielding property may be used as the organic insulating compound. In this manner, a leak of light from the pixels not emitting light can be prevented.

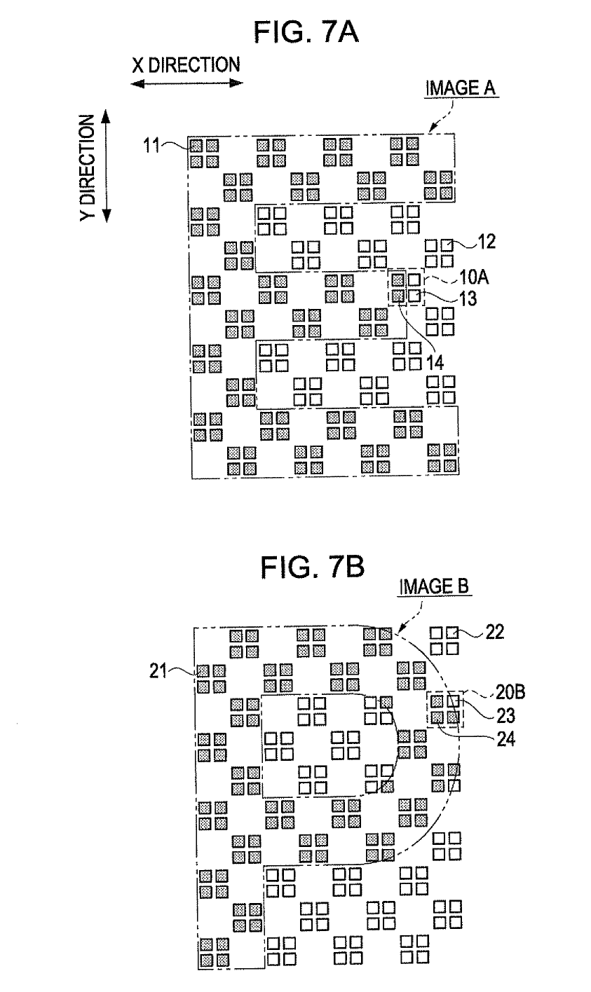

An example of the above operation will be described using FIGS. 7A and 7B. FIG. 7A is an explanatory diagram illustrating the case in which Roman letter “E” is displayed as the image A and FIG. 7B is an explanatory diagram illustrating the case in which Roman letter “P” is displayed as the image B.

First, as illustrated in FIG. 7A, when the image A is the Roman letter “E” of which a size and a shape are shown by an alternate long and two short dashes line, the pixels are uniquely classified into shaded pixels (for example, pixels 11) emitting light and outline pixels (for example, pixels 12) not emitting light. Accordingly, in the four pixels in the respective unit pixel areas sharing and displaying a portion of the image A, all the pixels emit light, all the pixels do not emit light, or a portion of the pixels emit light and the others do not emit light. For example, in an anode 10A which is an unit pixel area shown by the broken line in the drawing, pixels 14 emitting light and pixels 13 not emitting light are present.

Similarly, as illustrated in FIG. 7B, when the image B is the Roman letter “P” of which a size and a shape are shown by an alternate long and two short dashes line, the pixels are uniquely classified into shaded pixels (for example, pixels 21) emitting light and outline pixels (for example, pixels 22) not emitting light. Accordingly, in the four pixels in the respective unit pixel areas sharing and displaying a portion of the image B, all the pixels emit light, all the pixels do not emit light, or a portion of the pixels emit light and the others do not emit light. For example, in an anode 20B which is an unit pixel area shown by the broken line in the drawing, pixels 24 emitting light and a pixel 23 not emitting light are present.

Accordingly, as easily understood from the above description, in the respective unit pixel areas sharing the display of the images A and B, the pixels emitting light and the pixels not emitting light are different from each other in accordance with the contents of an image which is displayed as the image A or the image B. That is, in accordance with an image to be displayed, one pixel emits light or does not emit light. Thus, as described above, in accordance with whether the functional liquid discharged as the light-emitting layer for each pixel is a functional liquid including an organic light-emitting material or a functional liquid including an organic insulating compound as a material, one pixel can be made as a pixel emitting light or a pixel not emitting light.

In this embodiment, for the images A and B, at least the light-emitting layers are formed by discharging a functional liquid as described above. The functional liquid is discharged in the Y direction as the main scanning direction, and thus the same nozzles discharge the functional liquid to the pixels aligned in the Y direction. Accordingly, when the pixels are aligned in the Y direction with no gap therebetween, there is concern that vertically-striped uneven luminance, caused by a difference in functional liquid discharge amount frequently occurring in the nozzles, is visually confirmed. In this embodiment, the pixels are discontinuously arranged in the Y direction so that two pixels are present at intervals of one unit pixel area, that is, two pixels. Accordingly, there is an advantage in that it is difficult to visually confirm the vertically-striped uneven luminance.

As described above, thanks to the organic EL panel according to this embodiment, by applying a voltage between the anodes and the cathode, the voltage can be simultaneously applied to the pixels in all the unit pixel areas, which are electrically connected so as to belong to one of the images A and B. As a result, the pixels determined to emit light simultaneously emit light, and thus the image A or B can be displayed in the display range. Accordingly, without suppressing the switching operation of the driving element for each pixel, one image can be easily displayed in the substantially entire display range.

Furthermore, in this embodiment, as illustrated in FIGS. 7A and 7B, the unit pixel areas each formed of four pixels are disposed in the substantially entire display range without being adjacent to each other in the X and Y directions. Accordingly, since the unit pixel areas are dispersed in the entire display range and plural images can be displayed by the unit pixel areas dispersed in the entire display range, the displayed images A and B have almost the same display area. Moreover, due to the dispersion of the unit pixel areas, a distribution density of the unit pixel areas with respect to the display area is almost the same in the displayed images A and B. As a result, reduction in display qualities of the displayed images A and B is suppressed.

It is highly possible that, upon displaying the images A and B, the sums of currents flowing to all the unit pixel areas belonging to the respective images from the respective feed terminals 110 and 120 are almost the same since the distribution density of the unit pixel areas is almost the same in the displayed images A and B. Accordingly, a voltage can be applied using a power circuit capable of supplying the same capacity of current to the respective feed terminals 110 and 120, and thus there is no need to design plural power circuits and there is an advantage in that a load related to the design of the power circuit is reduced.

As described above, the invention has been described using the embodiments. However, it is obvious that the invention is not limited to the embodiments, but may be embodied in various forms without departing from the gist of the invention. Hereinafter, modified examples will be described.

### FIRST MODIFIED EXAMPLE

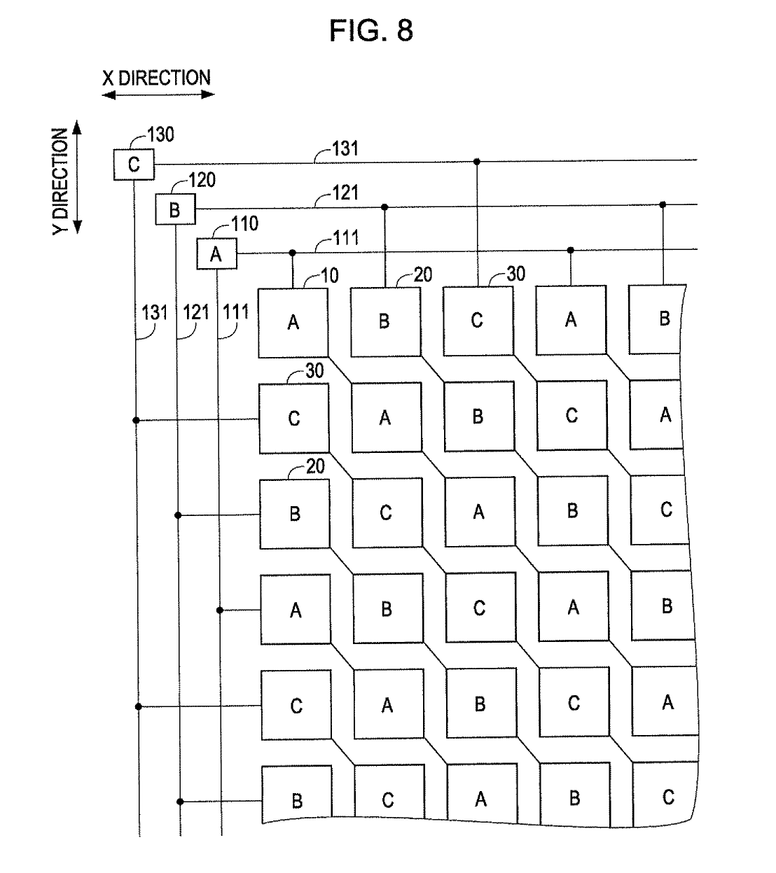

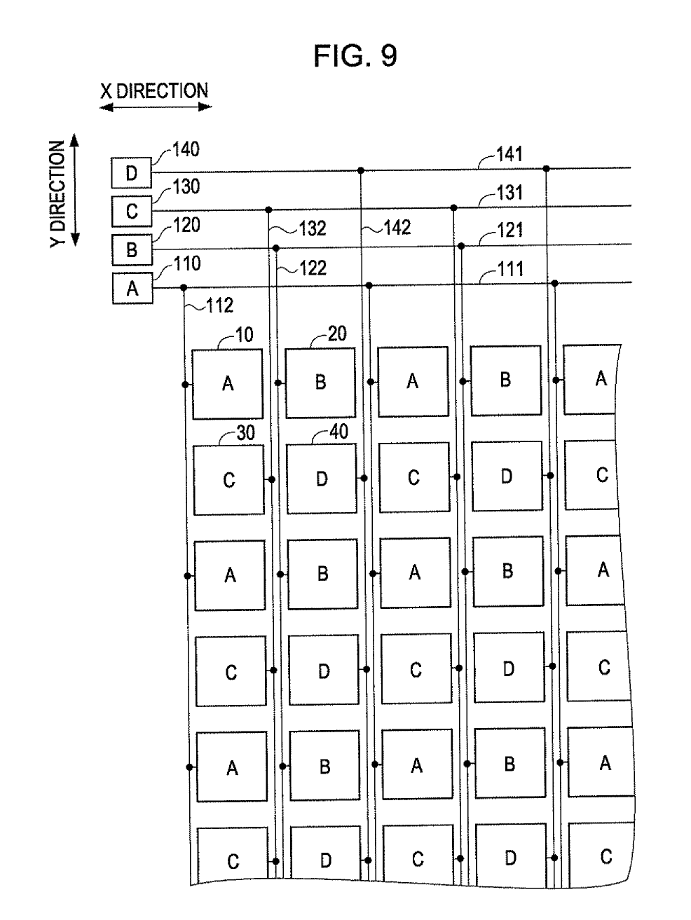

In the above embodiments, it has been described that the two images (images A and B) are displayed in the display range. However, the invention is not limited to this and a larger number of images may be displayed. For example, display of three images (images A, B and C) will be described with reference to FIG. 8 and display of four images (images A, B, C and D) will be described with reference to FIG. 9.

### (Display of Three Images)

FIG. 8 is a schematic diagram illustrating a portion of a wiring state on a substrate P. Also in this modified example, similarly to the above embodiments, anodes for respective pixels are formed to be divided into anodes 10, 20 and 30 so that one unit pixel area is formed of four pixels (not shown). In addition, the anodes are arranged in a repeated sequence of the anode 10, the anode 20 and the anode 30 in an X direction and in a repeated sequence of the anode 10, the anode 30 and the anode 20 in a Y direction. The anodes 10, 20 and 30 are electrically connected to each other in an inclined direction, respectively.

Herein, the anodes 10 belonging to an image A are configured to display the image A, the anodes 20 belonging to an image B are configured to display the image B and the anodes 30 belonging to an image C are configured to display the image C. That is, a voltage for displaying the image A is applied to a feed terminal 110 to electrically connect all the anodes 10 to the feed terminal 110 by a power supply line 111 extending in the X and Y directions from the feed terminal 110. A voltage for displaying the image B is applied to a feed terminal 120 to electrically connect all the anodes 20 to the feed terminal 120 by a power supply line 121 extending in the X and Y directions from the feed terminal 120. In addition, a voltage for displaying the image C is applied to a feed terminal 130 to electrically connect all the anodes 30 to the feed terminal 130 by a power supply line 131 extending in the X and Y directions from the feed terminal 130.

Due to the division of the anodes, when the three images are displayed in a display range, the unit pixel areas displaying one image are dispersed at certain intervals in the entire display range without being adjacent to each other in the X and Y directions. Accordingly, the three images can be displayed by the unit pixel areas dispersed in the entire display range, respectively.

As a result, the displayed images A, B and C have almost the same display area, which is an area range in which the unit pixel areas are present. Further, since the unit pixel areas are dispersed at certain intervals, a distribution density of the unit pixel areas with respect to the display area is almost the same in the displayed images A, B and C. As a result, display qualities of the displayed images A, B and C can be made almost the same.

### (Display of Four Images)

FIG. 9 is a schematic diagram illustrating a portion of a wiring state on a substrate P similarly to FIG. 8. Similarly to the above embodiments, anodes for respective pixels are formed to be divided into anodes 10, 20, 30 and 40 so that one unit pixel area is formed of four pixels (not shown). In addition, the anodes are arranged in a repeated sequence of the anode 10 and the anode 20 or the anode 30 and the anode 40 in an X direction and in a repeated sequence of the anode 10 and the anode 30 or the anode 20 and the anode 40 in a Y direction.

Herein, the anodes 10 belonging to an image A are configured to display the image A, the anodes 20 belonging to an image B are configured to display the image B, the anodes 30 belonging to an image C are configured to display the image C and the anodes 40 belonging to an image D are configured to display the image D. That is, a voltage for displaying the image A is applied to a feed terminal 110 to electrically connect all the anodes 10 to the feed terminal 110 by a power supply line 111 extending in the X direction from the feed terminal 110 and a line 112 connected to the power supply line 111 and extending in the Y direction. Similarly, a voltage for displaying the image B is applied to a feed terminal 120 to electrically connect all the anodes 20 to the feed terminal 120 by a power supply line 121 extending in the X direction from the feed terminal 120 and a line 122 connected to the power supply line 121 and extending in the Y direction. A voltage for displaying the image C is applied to a feed terminal 130 to electrically connect all the anodes 30 to the feed terminal 130 by a power supply line 131 extending in the X direction from the feed terminal 130 and a line 132 connected to the power supply line 131 and extending in the Y direction. A voltage for displaying the image D is applied to a feed terminal 140 to electrically connect all the anodes 40 to the feed terminal 140 by a power supply line 141 extending in the X direction from the feed terminal 140 and a line 142 connected to the power supply line 141 and extending in the Y direction.

Due to the division of the anodes, when the four images are displayed in a display range, the unit pixel areas displaying one image are dispersed at certain intervals in the entire display range without being adjacent to each other in the X and Y directions, as illustrated in the drawing. Accordingly, the four images can be displayed by the unit pixel areas dispersed in the entire display range, respectively.

As a result, the displayed images A, B, C and D have almost the same display area, which is an area range in which the unit pixel areas are present. Further, since the unit pixel areas are dispersed at certain intervals, a distribution density of the unit pixel areas with respect to the display area is almost the same in the displayed images A, B, C and D. As a result, display qualities of the displayed images A, B, C and D can be made almost the same.

The arrangement of the anodes 10, 20, 30 and 40 is not limited to the arrangement illustrated in FIG. 9. For example, the anodes may be arranged in a repeated sequence of the anode 10, the anode 20, the anode 30 and the anode 40 in the X and Y directions. In short, any arrangement can be employed if the electrically connected anodes are discontinuously arranged in the X and Y directions.

### SECOND MODIFIED EXAMPLE

In the above embodiments, the distribution density of the unit pixel areas belonging to the respective images is almost the same in the plural images displayed in the display range. However, the invention is not limited to this. When the number of images displayed in the display range is three or more, the distribution densities of the unit pixel areas belonging to the respective images may be different from each other. In this manner, for example, when the plural images are displayed in the display range, the unit pixel areas belonging to the respective images can be arranged in accordance with the distribution densities of the unit pixel areas necessary for visually confirming the display contents of the images.

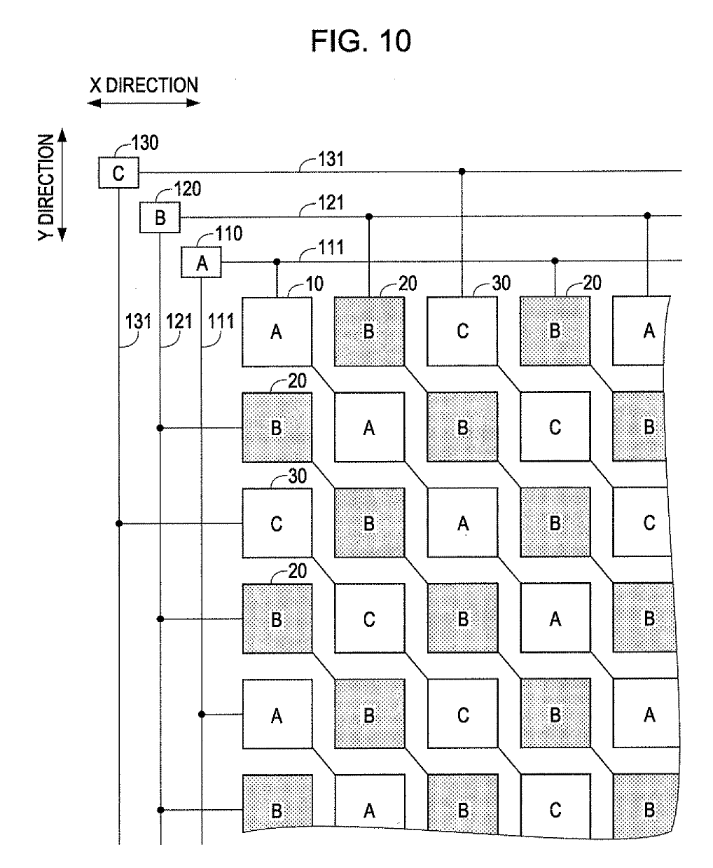

An example of this modified example will be described using FIG. 10. FIG. 10 is a schematic diagram illustrating a portion of a wiring state on a substrate P. Similarly to FIG. 8, the case in which three images are displayed in a display range is illustrated. Also in this modified example, similarly to the above embodiments, anodes for respective pixels are formed to be divided into anodes 10, 20 and 30 so that one unit pixel area is formed of four pixels (not shown). In addition, in this modified example, the anodes 10 to 30 are arranged in a repeated sequence of the anode 10, the anode 20, the anode 30 and the anode 20 in X and Y directions. The anodes 10, 20 and 30 are electrically connected to each other in an inclined direction, respectively.

Also in this modified example, the anodes 10 belonging to an image A are configured to display the image A, the anodes 20 belonging to an image B are configured to display the image B and the anodes 30 belonging to an image C are configured to display the image C. That is, a voltage for displaying the image A is applied to a feed terminal 110 to electrically connect all the anodes 10 to the feed terminal 110 by a power supply line 111 extending in the x and Y directions from the feed terminal 110. Similarly, a voltage for displaying the image B is applied to a feed terminal 120 to electrically connect all the anodes 20 to the feed terminal 120 by a power supply line 121 extending in the X and Y directions from the feed terminal 120. In addition, a voltage for displaying the image C is applied to a feed terminal 130 to electrically connect all the anodes 30 to the feed terminal 130 by a power supply line 131 extending in the X and Y directions from the feed terminal 130.

Due to the division of the anodes, when the three images are displayed in a display range, as illustrated by the shading in the drawing, a distribution density of the unit pixel areas belonging to the image B, that is, the entire display range of the anodes 20 is higher than a distribution density of the unit pixel areas belonging to the image A or C. Accordingly, for example, when the image B among the images A, B and C which are displayed in the display range is required to be displayed at a higher resolution than other images, a difference in display quality among the displayed images A, B and C can be suppressed by increasing the distribution density of the unit pixel areas belonging to the image B.

### THIRD MODIFIED EXAMPLE

In the above embodiments, it has been described that the color of the light emitted from the light-emitting layer formed for each pixel is white. However, the color is not limited to this. For example, in order to display a color image in the display range, the organic EL element formed for each pixel emitting light may be formed to emit light of red (R), green (G) or blue (B).

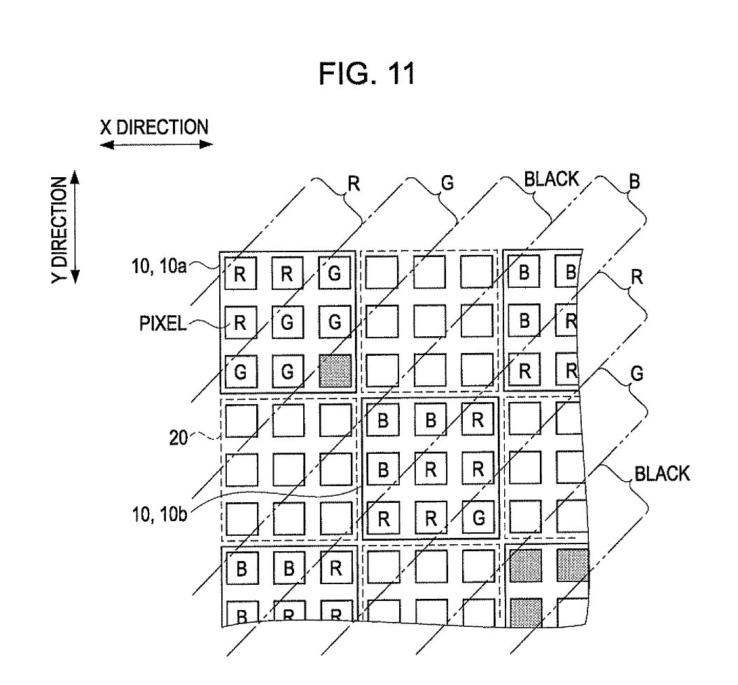

An example of this modified example will be described using FIG. 11. FIG. 11 is a schematic diagram illustrating the case in which two images are displayed in a display range. In this modified example, anodes are formed to be divided so that one unit pixel area is formed of the total nine pixels of three pixels in an X direction×three pixels in a Y direction. In addition, anodes 10 and 20 formed to be divided so that an image A which is one of the two images is displayed by the anodes 10 shown by the full line in the drawing and an image B which is the other of the two images is displayed by the anodes 20 shown by the broken line in the drawing are arranged and connected to a feed terminal (not shown), respectively.

When the image A is formed in an inclined stripe pattern in a right-ascending direction in the drawing, in which colors of “R, G, Black and B” are present in a repeated manner as illustrated in FIG. 11, the nine pixels in each anode 10 are formed to emit light of red (R), green (G) or blue (B) or not to emit light, respectively. For example, as illustrated in the drawing, the nine pixels in an anode 10a are formed to include the three pixels emitting light of R, the five pixels emitting light of G and the one pixel (shaded pixel) not emitting light. In addition, as illustrated in the drawing, the nine pixels in an anode 10b are formed to include the three pixels emitting light of B, the five pixels emitting light of R and the one pixel emitting light of G.

In this modified example, when an ink jet system is used to form the organic EL elements emitting R light, G light and B light, it is preferable that the above-described discharge head HD is provided with nozzle groups NB for discharging functional liquids which include organic light-emitting materials of R, G and B.

According to this modified example, in accordance with a color image which is displayed in the display range in such a manner, the colors of light to be emitted from the pixels in each unit pixel area are determined and thus plural color images can be displayed. When one of a functional liquid including an organic light-emitting material for determining the color of light to be emitted from the light-emitting layer and a functional liquid including an organic insulating compound is discharged to each pixel by the ink jet system, the light-emitting layer formed for each pixel can be arbitrarily changed in accordance with the image which is displayed.

### FOURTH MODIFIED EXAMPLE

According to a modified example of the third modified example, when a color image is displayed in a display range, it is preferable that anodes are formed to be divided so that the number of pixels emitting light of R, the number of pixels emitting light of G and the number of pixels emitting light of B are the same in one unit pixel area. In this manner, one unit pixel area functions as a picture element of the color image by adjusting light-emitting luminance of R, G and B in one unit pixel area. As a result, if the light-emitting luminance of R, G and B is adjusted for each unit pixel area, the color image can be displayed in the display range by using all the unit pixel areas.

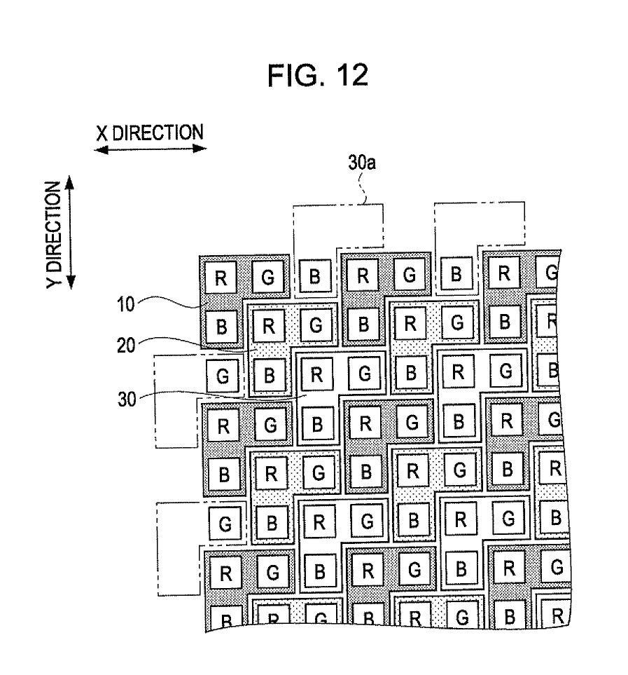

An example of this modified example will be described using FIG. 12. FIG. 12 is a schematic diagram illustrating the case in which three images are displayed in a display range. In this modified example, anodes are formed to be divided so that one unit pixel area is formed of the total three pixels of one pixel, one neighboring pixel in an X direction and one neighboring pixel in a Y direction. Anodes 10 shown as a darkly shaded portion in the drawing, anodes 20 shown as a lightly shaded portion in the drawing and anodes 30 shown as an outline portion in the drawing are arranged and connected to one feed terminal (not shown), respectively, so as to display an image, respectively. As a result, one unit pixel area functions as a so-called picture element including the pixels which emit light of R, G and B, respectively. Accordingly, by dividing the anodes in such a manner, picture elements are formed in which the pixels are collected without forming a longitudinal direction. Therefore, reduction in display quality of the respective images displayed in the display range can be suppressed. However, three pixels adjacent to each other in the X direction or three pixels adjacent to each other in the Y direction may be one unit pixel area.

In this modified example, a light-emitting layer is formed for each pixel by discharging a functional liquid including an organic light-emitting material emitting light of R, G or B. At this time, in accordance with an image to be displayed, a discharge amount of the functional liquid to be discharged by an ink jet system is changed in R, C and B. In this manner, since a thickness of the light-emitting layer to be formed can be changed, luminance of the respective light color of R, G and B can be changed for each unit pixel area. Accordingly, since a combined color of R, G and B can be adjusted for each unit pixel area, that is, picture element, a color image can be properly displayed in the display range. In this modified example, when the pixels of the entire unit pixel area do not emit light, that is, display a black color, it is preferable that the light-emitting layers of all the three pixels are formed of an organic insulating compound.

In this modified example, remaining pixels which cannot form a unit pixel area are present at the end of the display range. In this case, for example, like an anode 30a of FIG. 12, it is preferable that anodes are formed to be divided by determining that pixels are present around the display range, thereby forming unit pixel areas. In the above embodiments and modified examples, when remaining pixels which cannot form a unit pixel area are present at the end of the display range, it is preferable to carry out the same operation as in this modified example.

### OTHER MODIFIED EXAMPLES

In the above embodiments and modified examples, it has been described that one unit pixel area is formed of three pixels, four pixels or nine pixels. However, the invention is not limited to this and one or an arbitrary number of pixels may form the unit pixel area. The number of pixels adjacent to each other in X and Y directions is also not particularly limited to this. Moreover, shapes of unit pixel areas may not necessarily be the same as each other. The number of pixels included in one unit pixel area may be different depending on the unit pixel areas.

In addition, in the above embodiments, it has been described that the organic EL element is formed as an electroluminescent element and the functional layer formed by discharging and applying a functional liquid is the light-emitting layer (and hole injection layer). However, the invention is not necessarily limited to this. For example, when an electron injection layer is formed separately from the cathode, the electron injection layer may be the functional layer formed by jetting droplets. Or, when the light-emitting layer also serves as the hole injection layer, only the light-emitting layer may be the functional layer formed by discharging and applying a functional liquid.

Moreover, in the above embodiments, the organic EL element is formed as the display element. However, the invention is not limited to this and an inorganic EL element may be the display element. In addition, the display element is not limited to an electroluminescent element. Any one can be used as the display element if it functions as the display element. For example, a light-emitting diode may be formed in a pixel area. In this case, a functional layer to be formed is different from that of the above embodiments.

The entire disclosure of Japanese Patent Application No. 2008-165527, filed Jun. 25, 2008 is expressly incorporated by reference herein.

What is claimed is:

1. A display device comprising:
a plurality of first pixel electrodes which are arranged in a first direction and a second direction intersecting the first direction;
a plurality of second pixel electrodes which are arranged in the first and second directions;
a counter electrode which is formed to be opposed to the plurality of first pixel electrodes and the plurality of second pixel electrodes;
a first power supply line which electrically connects the plurality of first pixel electrodes; and
a second power supply line which electrically connects the plurality of second pixel electrodes,
wherein one or more pixels are formed to correspond to the respective pixel electrodes of the plurality of first pixel electrodes and the plurality of second pixel electrodes,
wherein a light-emitting layer made of an organic light-emitting material or an insulating layer made of an organic compound is disposed between a first electrode which is one of the plurality of first pixel electrodes and the counter electrode and between a second electrode which is one of the plurality of second pixel electrodes and the counter electrode, and
wherein power is supplied to the plurality of first pixel electrodes via the first power supply line upon displaying a first image and power is supplied to the plurality of second pixel electrodes via the second power supply line upon displaying a second image.

2. The display device according to claim 1,
wherein the insulating layer has a light-shielding property.

3. A display device which has an image display range in which a plurality of pixels are arranged in a matrix in a first direction and a second direction intersecting the first direction and displays a plurality of images in the image display range,
wherein one pixel or a pixel group of two or more pixels adjacent to each other in the first and second directions is classified as a unit pixel area in the display range, and
wherein the respective unit pixel areas display a partial image belonging to one of the plurality of images, and the one image to which the partial images displayed by the unit pixel areas belong is displayed differently in the unit pixel areas adjacent to each other in the first and second directions.

4. The display device according to claim 3,
wherein the pixels included in the unit pixel area are arranged in the same manner in all the unit pixel areas, except for a peripheral portion of the display range.

5. The display device according to claim 3,
wherein the plurality of pixels have an organic layer including a first electrode, a second electrode and a light-emitting layer sandwiched between the first electrode and the second electrode to emit light from the light-emitting layer by a current flowing between the first electrode and the second electrode, and
wherein the first electrode is electrically connected between the pixels present in all the unit pixel areas belonging to the one image, and the second electrode is electrically connected between all the pixels formed in the display range.

6. The display device according to claim 5,
wherein the plurality of pixels are classified into the pixels emitting light and the pixels not emitting light in accordance with the one image in the respective unit pixel areas belonging to the one image, and
wherein the organic layers of the pixels not emitting light include as the light-emitting layer a layer made of an organic compound having an electrical insulating property.

7. The display device according to claim 5,
wherein the pixels emitting light emit light having a color determined in accordance with the one image in the respective unit pixel areas belonging to the one image.

8. A method of manufacturing the display device according to claim 1, comprising:
forming at least the light-emitting layer in the respective pixels by an ink jet system discharging a functional liquid including a material for forming the light-emitting layer.

9. A display method of displaying a plurality of images in an image display range in which a plurality of pixels are arranged in a matrix in a first direction and a second direction intersecting the first direction,
wherein one pixel or a pixel group of two or more pixels adjacent to each other in the first and second directions serves as a unit pixel area in the display range, and
wherein when the respective unit pixel areas display a partial image belonging to one of the plurality of images, the one image to which the partial images displayed by the unit pixel areas belong is displayed differently in the unit pixel areas adjacent to each other in the first and second directions.
